(19) United States
(12) Patent Application Publication
(10) Pub. No.: US 2005/0210056 A1
(43) Pub. Date: Sep. 22, 2005

(54) Workstation information-flow capture and characterization for auditing and data mining

(76) Inventors: Itzhak Pomerantz, Kefar-Sava (IL); Ramy Metzger, Oranit (IL); Abraham Meidan, Tel-Aviv (IL); Moshe Basol, Ra'anana (IL); Ishay Ventura, Modi'in (IL)

Correspondence Address: Itzhak Pomerantz, 18 Golomb Street, Kefar-Sava, 44357, IL

(21) Appl. No.: 11/043,472

(22) Filed: Jan. 27, 2005

Related U.S. Application Data
(60) Provisional application No. 60/481,984, filed on Jan. 31, 2004.

(51) Int. Cl. G06F 7/00

(52) U.S. Cl. 707/101

(57) ABSTRACT

A method and system for capturing and characterizing data displayed on a workstation screen, and user manipulation, to support auditing and data mining of user information access. Capture and characterization are independent of application and network connectivity, so data from different applications can be captured, characterized, and analyzed and correlated in a uniform manner. Screen data is captured as machine-readable text-string words associated with meta-data attributes detailing circumstances and characteristics of screen data presentation, and user control of software applications and windows. Characteristics include: workstation identifier; application; date and time of display; coordinates of screen data; window opening, closing, and scrolling; searching, copying, printing, and saving. The invention can be used to determine patterns of normal operation, to investigate information access misuse, and as a watchdog for alerts to potentially abusive information access practices.

The present application claims benefit of U.S. Provisional Application number 60/481984 filed Jan. 31, 2004.

### FIELD OF THE INVENTION

The present invention relates to methods for data collection, characterization, and analysis, and, more particularly, to a system and method for capturing and structuring meta-information descriptive of information accessed via workstations by users thereof.

### BACKGROUND OF THE INVENTION

The personal computer (PC) workstation has become the principal tool for writing, reading, communicating, data manipulation, and storage in information-intensive organizations. The term “workstation” herein denotes any computer or computer-related device having a visual display and means of manual information input, which allows a user to personally input information, and to access, receive, select, and modify information. For purposes related to the present application, workstations include, but are not limited to: personal computers, computer terminals, digital assistants and digital appliances, and telephonic devices with data viewing capabilities. Means of manual information input include, but are not limited to: keyboards and keypads; pointers, such as mouse, trackball, and joystick; touch-sensitive surfaces; and stylus.

With the advent of local- and wide-area networking, the workstation has attained dramatically-increased importance, significance, and scope. The workstation has enabled businesses and institutions to achieve unprecedented efficiency and versatility, but the dependence on workstations has introduced new levels of vulnerability. The misuse of critical or sensitive information placed on networks and in storage devices that is now available via workstations through servers can cause great damage or loss to an organization. Not only can the organization suffer extensive fmancial losses, but the organization's reputation and integrity can be severely compromised should trusted information be revealed or abused. There is also a heavy potential liability should innocent persons suffer damages through a breach of confidence. Although considerable advances have been made in the securing of information against unauthorized access through cryptographic techniques and other means, the fact remains that information necessarily must be available for some authorized access, and when available to an authorized user, the information cannot be completely protected.

The hazards to which sensitive information is exposed through access to authorized persons includes negligence in handling as well as intentional misuse through breach of trust, conflict-of-interest, and misrepresentation, for the committing of malicious vandalism, theft, extortion, espionage, and fraud. The modes of abuse involve individual initiatives in addition to conspiratorial attacks.

Restricting and limiting the number and privileges of authorized users can lessen, but not completely eliminate this vulnerability. In general, there is a tradeoff between protecting information and policing the users. Protecting information can prevent abuse, but may be costly, may introduce adverse factors from a standpoint of efficiency, and may compromise other organizational goals. For example, in certain extremely sensitive situations, it is sometimes possible to distribute information authorization privileges among different, widely-separated individuals in such a manner as to prevent any single one of them from being able to access and view enough information to constitute a serious threat, and in such a way that it is highly unlikely that the individuals could collude. Operating in such a manner, however, is generally prohibitive from both management and financial standpoints, and cannot be justified for the handling of most ordinary data. Abuse of ordinary data, however, can also involve serious damage. The alternative to protecting the information is to encourage and enforce acceptable practices on the part of the authorized users, by facilitating the survey and investigation of their information access and viewing patterns and histories. The widespread employment of workstations in the access and viewing of information makes it logical to focus on the workstation as the ideal point of collecting and organizing meta-information related to the usage patterns and histories of the users as they access and view the subject information.

By keeping records of authorized user access and viewing, it is possible, for example, to investigate how a particular information leak occurred and who was responsible for it. Furthermore, by employing some ongoing statistical tests on the collected information via software “watchdog” agents, it may be possible to detect a potentially-detrimental condition (such as an attempt to impersonate another user or to disguise or cover up the accessing of information) or pattern (such as a sudden divergence from the normal usage profile), and alert the appropriate human agencies to take preventive action and institute corrective measures to minimize future risk, even before a loss has occurred.

To achieve these goals, organizations need comprehensive tools for: auditing the trail of workstation information access and viewing at various levels; analyzing patterns of legitimate workstation information access and viewing, and comparing those patterns against actual workstation usage; compiling workstation information access and viewing statistics and correlation; monitoring for compliance; and preparing documentation to prosecute offenses. Judiciously-applied, such tools could not only put a stop to abusive practices by authorized personnel, but could also establish standards for responsible information access and viewing (for example, to develop and implement an organization's “acceptable use policy” for information) and could serve as an effective deterrent to abuse.

There are several desirable capabilities and characteristics that comprehensive tools should have to perform the needed functions:
The tools should be able to keep accurate records of the information accessed at each workstation, including the time, the application accessing the information, the specific information accessed and visible, the context in which the information was accessed and potentially viewed, and whether the information was altered and/or copied.
The records should permit a relatively complete reconstruction of the accessed information, the environment in which the information was accessed and viewed, and the trail of information accessing and viewing.
The reconstruction ideally should be able to regenerate and represent the more complex knowledge that is typically created and communicated among organization personnel, that is not necessarily portrayed in normal documentation, and is therefore not searchable by conventional tools.
The records should allow determination of which items of information were accessed and viewed simultaneously or in an interconnected sequence, and/or whether there may have been any following interaction or relationship between these different items (e.g., details of two different items of information were both copied into the same e-mail message).
In addition to accumulating meta-information, the collection process should preserve as much of the relevant information content itself, in machine-readable and analyzable form, to allow automated reconstruction, correlation, and “data mining”, and extraction of usage patterns and profiles.

The goal is to facilitate the construction of a meaningful audit trail and to provide “watchdog” software agents with sufficient on-going raw data for their operation.

Of course, it is necessary that the tools be able to perform their function in a manner that is transparent to the users. It is also necessary that the tools employ automated mechanisms and modern data-handling techniques to the greatest extent possible. For example, the collected data should be compressed and encrypted for optimal and secure storage. A high degree of compression is desirable, because very large quantities of information may need to be stored. It is also desirable to arrange the collected data in a suitable database format that facilitates rapid retrieval on an ad hoc basis (for “data mining”). This not only reduces the time and cost of processing, analyzing, and handling the collected meta-information and associated content information, but also allows the collected data (which is itself potentially sensitive) to be kept confidential and unseen unless a need arises. In employing such investigative tools, it is important to realize that the authorized users themselves need to be protected. An authorized user of sensitive information must respect the confidentiality of the information and adhere to the “acceptable usage” policies of the organization, but at the same time needs to feel comfortable that he or she can engage in work without fear of being spied upon.

There are a number of solutions in the prior art, all of which currently exhibit various limitations that render them only partially satisfactory.

The simplest scheme for auditing the access and viewing of information on a workstation is to accumulate “screen shots” of what the authorized user was able to see. FIG. 1 conceptually illustrates such a scheme. A workstation 100 includes a display 101 and a keyboard 103, as well as a pointing device (e.g., a mouse) 104. Optionally, workstation 100 is connected to a network 105 via a link 107. The display on screen 101 is obtained via a capture operation 109. A captured screen image 111 (in this example) contains a window 113, a window 115, and a window 117. As shown in an enlargement 119, however, text 121 appearing in captured screen image 111 is merely a bitmap 123 of the text characters. Thus, although captured screen image 111 is rich with visual information, the logical information content is difficult to extract. In other words, the screen capture scheme is not particularly useful in an automated system.

FIG. 2 conceptually illustrates another prior art scheme for capturing information from a workstation session. In this scheme, keystrokes from keyboard 103 are intercepted in a capture operation 201 and stored as text in a special account 203. This scheme is able to capture different types of data input into files, such as a document 205, an e-mail message 207, and chat room conversations 209. This special account is made available to network 105 via a connection 211. Although the files output by this scheme are readily machine-readable (unlike those of the screen capture scheme illustrated in FIG. 1), a lot of information is lost and unavailable for investigation. For example, the information visible to the user on screen 101 is not sampled or captured. In other words, the keyboard capture scheme works well with automated systems, but significant amounts of information are bypassed.

FIG. 3 conceptually illustrates one more prior art scheme for capturing information from a workstation session. In this scheme, input to and output from certain specific applications is captured into a special account 305. For example, a word processor application 301 and a spreadsheet application 303 are captured by capture operations 307 and 309, respectively, into files 311 and 313, respectively. Special account 305 can be made available to network 105 via a connection 315. In this scheme, the visible content of screen 101 and the input of keyboard 103, as well as input via pointing device 104, is captured, but only for those certain specific applications which are supported. An unsupported application 317 is not recognized, nor is the information input or viewed within application 317 captured. In other words, the application capture scheme works well with automated systems, and handles information both input by the user and shown to the user, but only for individual and isolated applications, with potentially significant information in other applications bypassed.

FIG. 4 conceptually illustrates yet another prior art scheme for capturing information from a workstation session. In this scheme, communication to and from network 105 is captured into a special account 405 via a connection 411. All interactions with any network applications are automatically captured. For example, the user's interaction with a network browser application 401 is automatically captured into a file representation 407. Likewise, the user's activity with an e-mail application 403 is automatically captured into a file representation 409. The advantage of this approach is that all applications which access and interact with network 105 are automatically included. Unfortunately, however, not everything the user does on workstation 100 is handled over network 105. For example, many network applications (including most browsers) provide for off-line operation. In addition, many applications have nothing to do with network 105 at all. In particular, encrypted information can be intercepted at any point, including connection 411, but this information is in ciphertext form and is unintelligible and useless for auditing. it is only information in plaintext form (prior to encryption or subsequent to decryption) that can be used for auditing, and in this form the information is not sent over network 105. Thus, the network capture scheme works well with automated systems, and handles information both input by the user and shown to the user, but only for data sent in plaintext form over the network, with potentially significant information not sent in plaintext form over the network bypassed.

As noted above in detail, the prior art solutions all exhibit limitations which prevent them from realizing the desirable capabilities and characteristics previously discussed.

There is thus a need for, and it would be highly advantageous to have, a workflow auditing system that is combined with a knowledge management system for realizing the desirable capabilities and characteristics. This goal is met by the present invention.

### SUMMARY OF THE INVENTION

The present invention is of a system and method for capturing information both input to a workstation by a user and output from the workstation to the user independent of any network connectivity and independent of the workstation applications currently running, such that input to and output from the workstation is captured substantially for substantially all applications.

An object of the present invention is to determine the exposure of visible information to a workstation user. That is, information which the user could potentially see on the workstation screen, taking into account the actual display parameters of the information. As a non-limiting example, consider a particular application window on the screen. In general, the window is not capable of displaying the entire information of the application, and is thus provided with “scrolling” capabilities by which the reduced portion of information displayed in the window can be changed. Application information which is currently not displayed in the window, and which needs to be scrolled into view is not considered exposed to the user. Should the user scroll the information into view, however, the information is thus exposed to the user. Likewise, a first window may cover up information on a second window. Unless the user closes, minimizes, moves, resizes the first window, brings the second window to the “top” of the first window, or otherwise manipulates the screen so that the first window does not cover the information on the second window, the information is not considered exposed to the user.

Another object of the present invention is therefore to capture, log, and characterize the user's manipulation of the workstation graphical user interface (GUI). Such manipulations include, but are not limited to: launching and shutting down (closing) software applications; opening and closing windows; moving, resizing, minimizing, maximizing, and scrolling windows; selecting text and other objects; finding, copying, and pasting text; copying text from one window to another; saving data in new files (file “save as” operation); printing information; uploading information to a network; file transfers.

Moreover, a system or method according to the present invention captures all information shown to the user and input by the user in a form which facilitates automatic analysis, auditing, and data mining. In particular, data is captured as a machine-readable text string along with meta-data attributes detailing the circumstances and particular characteristics of the presentation of the data on the screen.

Furthermore, a system or method according to the present invention also captures certain relationships among various items of information, including but not limited to: temporal relationships pertaining to the time of appearance on the screen; spatial relationships pertaining to the positions on the screen; application relationships pertaining to data words appearing in the same or related windows; and grammatical relationships pertaining to text appearing in the same grammatical unit (e.g., clause, sentence, paragraph, etc.). This information is useful in establishing a correlation between different items which may be associated with different applications.

It will be understood that a system according to the present invention may be a suitably-programmed computer, and that a method of the present invention may be performed by a suitably-programmed computer. Thus, the invention contemplates a computer program that is readable by a computer for emulating or effecting a system of the invention, or any part thereof, or for executing a method of the invention, or any part thereof. The term “computer program” herein denotes any collection of machine-readable codes, and/or instructions, and/or data residing in a machine-readable memory or in machine-readable storage, and executable by a machine for emulating or effecting a system of the invention or any part thereof, or for performing a method of the invention or any part thereof.

Therefore, according to the present invention there is provided a method of determining the information exposed to a workstation user by directly capturing and characterizing information appearing on a workstation screen, the method comprising: (a) getting a data word from the workstation screen; (b) associating the data word with the position of the data word on the workstation screen; and (c) recording, in a screen list in persistent storage, the data word with the position.

Also, according to the present invention there is provided a method for characterizing the relationship between a first data word and a second data word, each data word having a position on a workstation screen, each position having a horizontal component and a vertical component, the method including: (a) obtaining the workstation screen position of the first data word; (b) obtaining the workstation screen position of the second data word; and (c) calculating a distance between the first data word and the second data word according to a function selected from the group consisting of: (i) the absolute value of the difference between the horizontal components of the position of the first data word and the second data word; (ii) the absolute value of the difference between the vertical components of the position of the first data word and the second data word; and (iii) the square root of the sum of the squares of the difference between the horizontal components of the position of the first data word and the second data word and the difference between the vertical components of the position of the first data word and the second data word.

In addition, according to the present invention there is provided a method for characterizing the relationship between a first data word and a second data word, each data word having a time of appearance on a workstation screen, the method including: (a) obtaining the time of appearance on the workstation screen of the first data word; (b) obtaining the time of appearance on the workstation screen of the second data word; and (c) calculating the time difference between the appearance of the first data word and the appearance of the second data word.

Moreover, according to the present invention there is provided a method for characterizing the relationship between a first data word and a second data word, each data word having a grammatical position in the same text stream appearing on a workstation screen, the method including: (a) obtaining the grammatical position of the first data word; (b) obtaining the grammatical position of the second data word; and (c) calculating the difference between the grammatical position of the first data word and the grammatical position of the second data word.

Furthermore, according to the present invention there is provided a database record for logging and characterizing a user's manipulation of a workstation having a graphical user interface, a set of applications including specified and non-specified applications, and windows with scroll-rest positions, the database record comprising at least three different fields selected from the group consisting of: (a) total number of windows opened during a workstation session, for specified applications; (b) total number of windows opened during a workstation session for non-specified applications; (c) maximum scroll-rest position for a window; (d) average scroll-rest position for a window; (e) maximum time an application was running; (f) average time a set of applications were running; (g) maximum number of times text was copied out of an application; (h) average number of times text was copied out of a set of applications; (i) maximum number of print commands from an application; (j) average number of print commands from a set of applications; (k) maximum number of “save as” commands from an application; (l) average number of “save as” commands from a set of applications; (m) maximum number of text find commands from an application; (n) average number of text find commands from a set of applications; and (o) the number of occurrences of a particular application sequence.

Additionally, according to the present invention there is provided a system for capturing, collecting, analyzing, and reporting information about data displayed on a workstation to a user according to a query, the system including: (a) a data word content characterizer, for creating a screen list; (b) a data word selector, for creating a subset of the screen list according to the query; (c) a data word relationship analyzer, for determining interrelationships between words in the subset; (d) a database for containing the interrelationships; (e) a user activity characterizer, for determining user patterns; and (f) a database manager.

### BRIEF DESCRIPTION OF THE DRAWINGS

The invention is herein described, by way of example only, with reference to the accompanying drawings, wherein:

FIG. 1 conceptually illustrates a prior art screen capture scheme for auditing information access and viewing.

FIG. 2 conceptually illustrates a prior art keyboard capture scheme for auditing information entry.

FIG. 3 conceptually illustrates a prior art application capture scheme for auditing information entry and viewing.

FIG. 4 conceptually illustrates a prior art network capture scheme for auditing information entry and viewing.

FIG. 5 illustrates the attributes of a data word according to embodiments of the present invention.

FIG. 6 illustrates an example of a workstation screen containing a number of windows with typical data words.

FIG. 7 illustrates a scheme according to the present invention for associating individual data words with screen positions.

FIG. 8 is a flowchart illustrating an embodiment of a method according to the present invention, for capturing and characterizing data words that appear on a workstation screen.

FIG. 9 illustrates a flowchart of a method for the compilation and processing of application records during a user session, according to an embodiment of the present invention.

FIG. 10 is a block diagram of a system according to an embodiment of the present invention.

FIG. 11 conceptually illustrates an example of an audit trail screen according to an embodiment of the present invention.

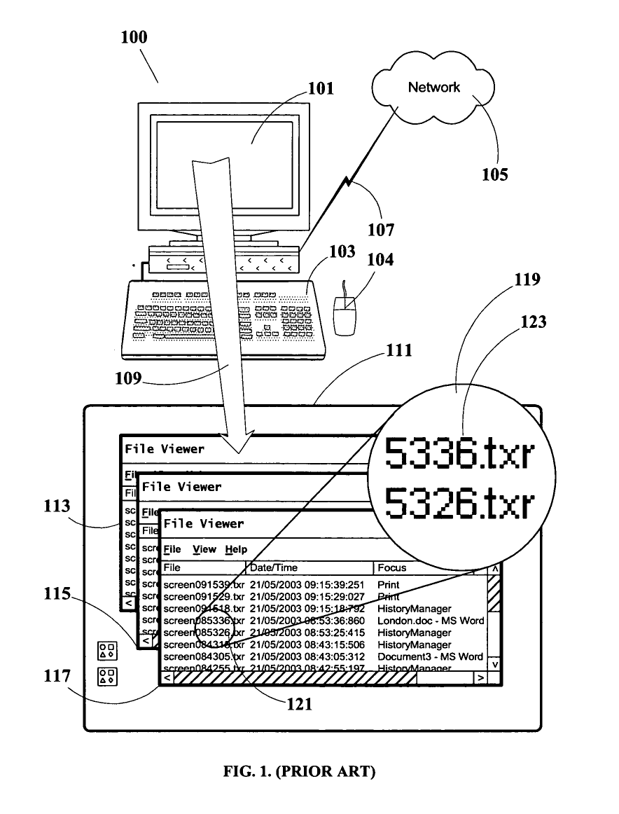

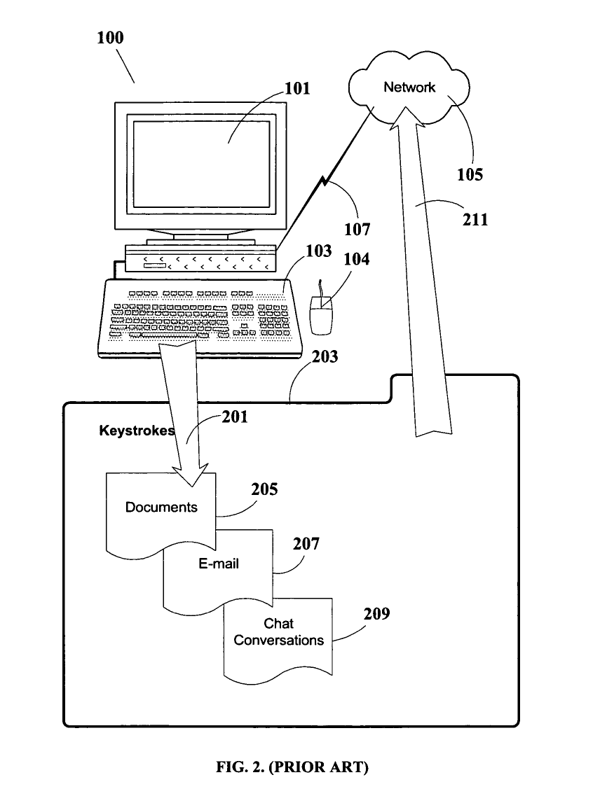

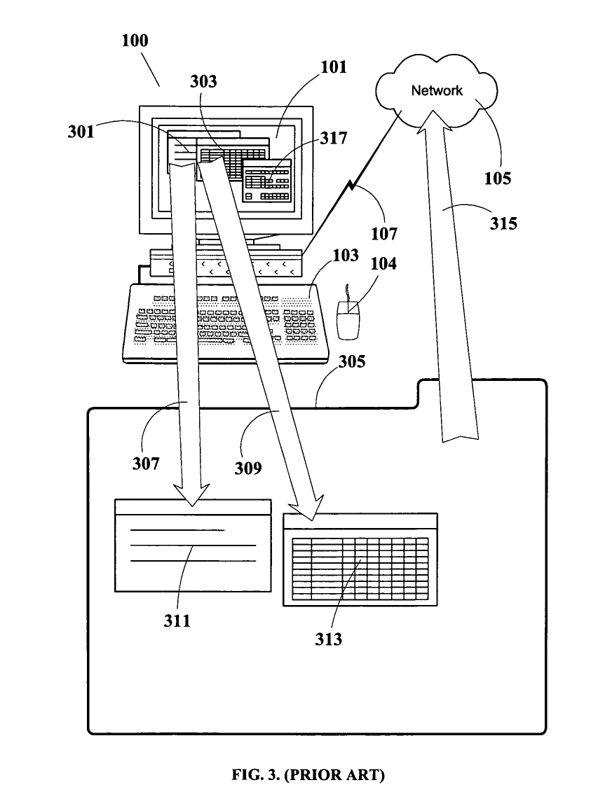

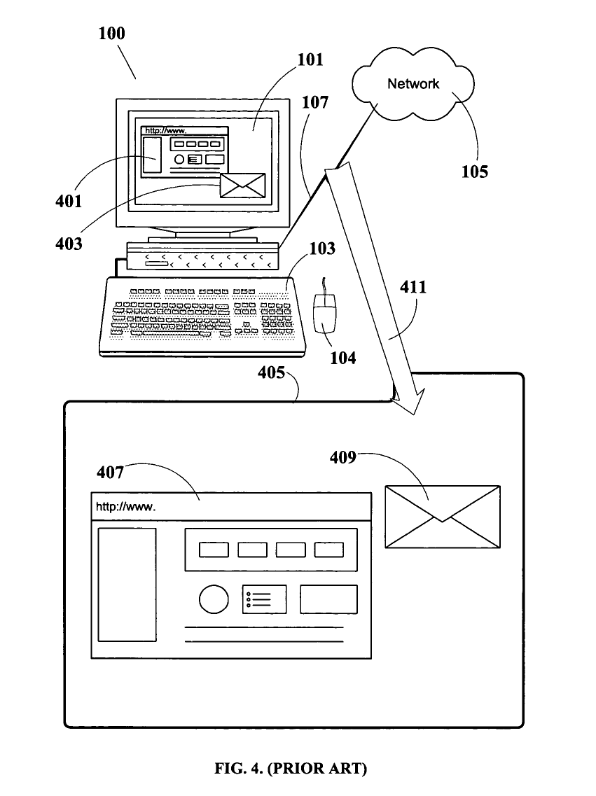

### DESCRIPTION OF THE PREFERRED EMBODIMENTS

The principles and operation of a system and method according to the present invention may be understood with reference to the drawings and the accompanying description.

Data Words

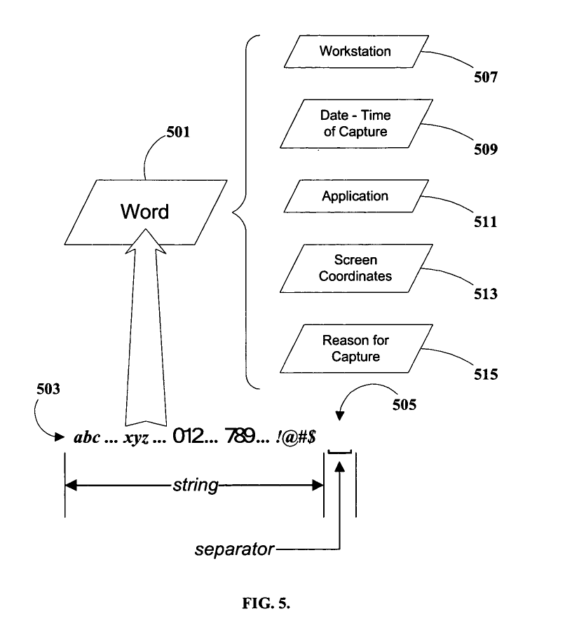

The terms “data word” and “word” herein denote a basic data element captured by embodiments of the present invention. As illustrated in FIG. 5, a word (or “data word”) 501 is a string 503 of printable characters terminated by a separator 505. In embodiments of the present invention, the printable characters of a string include alphanumeric characters and non-alphanumeric characters; and separator 505 is a space. Non-limiting examples of words include “Jones”, “telephone”, “05/14/2003”, and “$3523.34”. Word 501 has a set of attributes, including but not limited to: a workstation attribute 507, which identifies the workstation from which the word was captured; a date-time of capture attribute 509; an application attribute 511, which identifies the application (e.g., spreadsheet, word processor, etc.) from which the word was captured; a screen coordinates attribute 513, which identifies the position of word 510 on screen at the time of capture; and a reason for capture attribute 515, which indicates the event which initiated the capture, including but not limited to: periodic (timer event) capture; keyboard event; operating system event; windowing event; and text event).

Workstation Screens

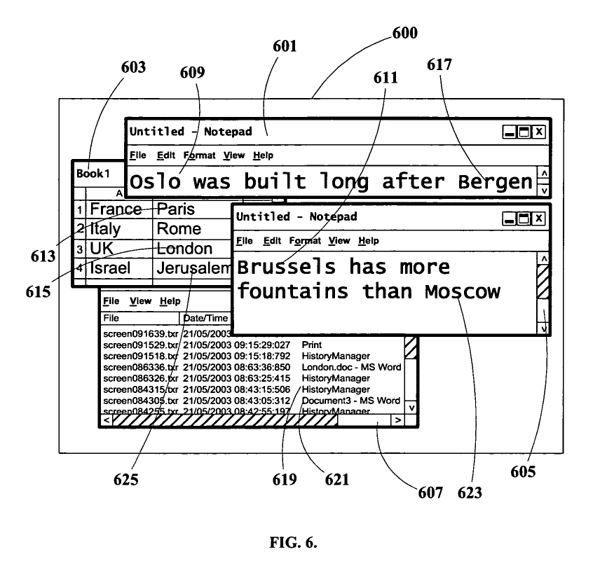

FIG. 6 illustrates a non-limiting example of a workstation screen 600 displaying a text editor window 601, a spreadsheet window 603, a text editor window 605, and a database window 607 with typical data. A word 609 and a word 617 are in the same line of text and within the same sentence, and are thus grammatically proximate. The grammatical position of a word is defined as the integer position of the word from the beginning of the text stream in which the word appears. The grammatical distance between two words is thus the difference in the grammatical positions of those words. A word 613 and a word 615 are vertically proximate. A word 611 and a word 623 are in the same window, and word 611 is horizontally proximate to a word 625. A data word 619 and a data word 621 are temporally proximate (time-stamped within 15 seconds). Data words can also be temporally proximate in a meta-data sense, by appearing on the screen at the same time, or within a very short time of one another. This example is typical of the type of workstation input and output encountered in a working environment.

Data Word Characterization

In order to analyze the viewability and proximity of various data words, it is necessary to separately identify and characterize each of the individual data words appearing on the screen.

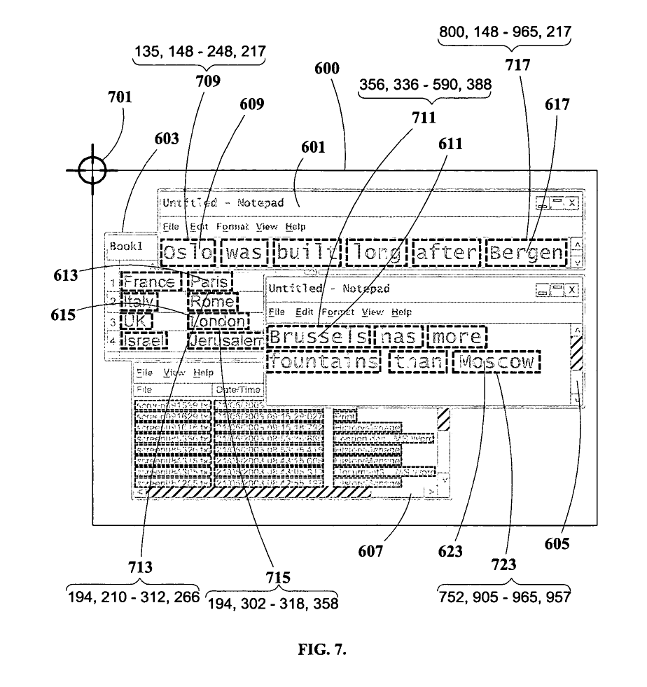

FIG. 7 illustrates the screens of FIG. 6, but with the individual data words identified as separate objects having meta-data attributes associated with screen position and extent. In this non-limiting example, both position and extent are expressed in x, y pixel positions on the screen, considering the upper left corner of the screen to be an origin 701 (where x=0, y=0), with x increasing to the right and y increasing downward, for a common screen size of 1024 pixels wide by 768 pixels high. A data word on the screen is associated with a “bounding box”, which is a rectangle aligned orthogonally with the screen axes, and which contains that data word and only that data word. A common format for characterizing the position and extent of a bounding box is the x, y position of the upper left-hand comer followed by the x, y position of the lower right-hand comer. In the example of FIG. 7, word 609 has a bounding box 709 with a position and extent given in this format as 135, 148-248, 217. That is, the upper left-hand comer of bounding box 709 is located 135 pixels to the right (of screen origin 701) and 148 pixels down (from screen origin 701), and the lower-right comer of bounding box 709 is located 248 pixels to the right and 217 pixels down. Likewise, word 617 has a bounding box 717 given as 800, 148-965, 217. It can readily be determined analytically, by comparing the position and extent attributes of bounding box 709 with those of bounding box 717, that the y-coordinates are identical, and that bounding box 709 is therefore on the same line of the screen as bounding box 717. Because their respective bounding boxes are on the same line, word 609 can thus be determined analytically to be on the same line as word 617. These and other relationships are visually obvious, but by using the well-known bounding box technique, it is possible to determine such relationships in a non-visual manner, by computer. Other tests are also possible, to determine whether different bounding boxes are within the same window on the screen, and so forth. Also illustrated are a bounding box 711 (356, 336-590, 388) for word 611, a bounding box 723 (752, 905-965, 957) for word 623, a bounding box 713 (194, 210-312, 266) for word 613, and a bounding box 7l5 (194, 302-318, 358) for word 615. It is noted that the horizontal extent of bounding box 715 overlaps that of bounding box 713, i.e., that they are aligned vertically in some fashion. It is emphasized that in this non-limiting example, position is measured in screen coordinates (pixels), but other position units are also possible, such as centimeters or inches.

The identification of the individual data words on the screen and determining their respective bounding boxes is well-known in the art and can be accomplished by capturing display commands at the operating system level. By capturing the commands at the operating system level, it is possible to identify and locate data words in a manner that is generally independent of the specific applications involved. The terms “direct” and “directly” as used herein within the context of capturing data words from a workstation screen denote capture that is substantially independent of the application involved. Thus, capturing data words directly from the workstation screen can be accomplished via the operating system in a manner that does not depend on the applications that are currently running.

Most data-oriented software applications (as distinct from real-time video display-oriented applications, such as computer games and the like, which may bypass the operating system for performance considerations) perform display of data words via the operating system, and therefore capturing display information with the use of operating system internals allows embodiments of the present invention to capture data words directly from the workstation screen and thus to track data words from substantially all relevant applications.

Commercial software with such capabilities for the Microsoft Windows operating system is available from vendors such as Commodio (Kfar Sava, Israel—www.commodio.com). The Commodio software analyzes screen content and compiles a real-time collection of visible objects, such as: text and other data words; graphics; images; and graphical user interface (“GUI”) controls within the Windows operating system. This collection includes the properties of the data words and can be used as a “mirror” or “replica” of the current screen content. An important property of a data word is the position on the screen where the data word was located. Additional relevant properties include, but are not limited to:
the screen (i.e., workstation or user) on which the data word was displayed;
the particular software application which displayed the data word;
the particular window where the data word appeared;
the date and time the data word appeared on the screen;
the date and time the data word changed position on the screen;
the date and time the data word disappeared from the screen; and
the event which initiated the capture (e.g., keystroke event, pointing device event, operating system event, application event, timer event, and so forth).
A timer event is an operating system event which takes place after a specified amount of time has passed, and may be self-repeating, so that the timer event will automatically occur at regular predetermined time intervals.

Prior art software, such as from Commodio, however, has only a short-term use for the collection of data words, and discards the collection as soon as the screen display changes. Embodiments of the present invention, however, compile and retain a “screen list” of data words and their attributes in persistent storage for long-term use. Persistent storage includes, but is not limited to, any machine-readable medium or memory capable of retaining retrievable data for an extended period of time. A screen list in persistent storage is a novel feature of the present invention.

Such a screen list includes all the data words and their meta-data appearing in the example of FIG. 7, and can be employed for the method and system of the present invention.

It is noted that time resolutions are of the order of one second.

Method for Capturing, Characterizing, and Logging Information Exposed to the User

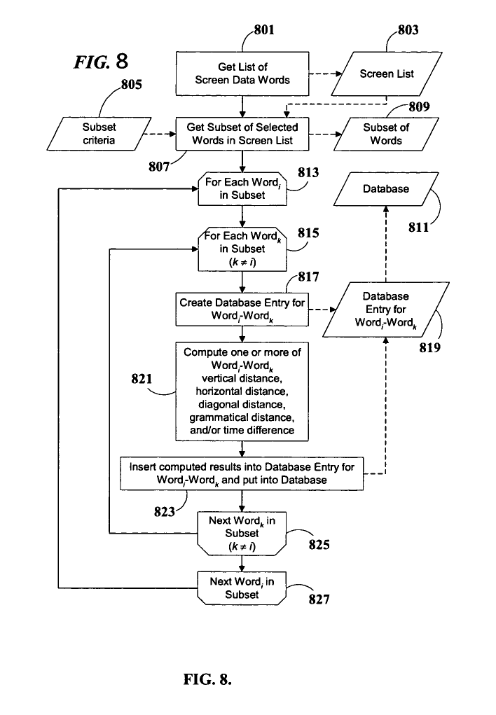

FIG. 8 is a method flowchart detailing an embodiment of the present invention for capturing, characterizing, and logging data words that are exposed to the user by visibly appearing on a workstation screen. This method continuously logs a user's exposure to information by capturing and recording text that is visibly displayed on the workstation screen. The text is captured in machine-readable form in a manner that is independent of network connectivity and independent of the particular application that the user is currently running. This method captures text from substantially all applications that run on the workstation.

In a step 801, a screen list 803 is generated. This screen list, for example, could be as shown in FIG. 7 and obtained as discussed above. To generate the list, each data word appearing on the screen is obtained. Then, the position of the data word on the screen is associated with the word, and the data word and corresponding position are recorded in screen list 803. It is noted that screen list 803 is machine-readable, but may reside in memory or other temporary storage. Screen list 803 may be stored in a permanent data file, but this is not necessary. In addition, other relevant properties of the data words (as listed above) can also be associated with the data words in the list. A subset criteria 805 specifies which of the data words in screen list 803 should be selected. Then, in a step 807, the selected words are obtained and placed in a subset 809. Typically, the selected data words in the subset will be words of text with some common significance. As a non-limiting example, the selected data words could be names and terms of special interest. As another non-limiting example, the selected data words could be words which are not in a list of words predetermined to carry little or no information (e.g., “a”, “an”, “the”)—this is discussed below in more detail when considering database compacting. As a further non-limiting example, the subset criteria could include the entirety of screen list 803 (i.e., the subset is the screen list itself, and in effect, no subset is taken). From this point onward, the method constructs a database 811 of relationships between the words in subset 809. In an outer loop start 813, each wordᵢ in subset 809 is selected. In each iteration of the outer loop, an inner loop start 815 selects each wordₖ in subset 809 such that k≠i. In each iteration of the inner loop, a step 817 creates a database entry 819 for the wordᵣ-wordₖ pair. Then a step 821 computes one or more of the vertical, horizontal, diagonal, grammatical distances between wordᵢ and wordₖ, and/or the difference in time between the appearances of wordᵢ and wordₖ on the screen. It is noted that horizontal and vertical distances between two words are calculated as the absolute value of the difference of the horizontal and vertical position components, respectively. The diagonal distance between two words is calculated as the Pythagorean distance (the square root of the sum of the squares of the vertical and horizontal distances). The grammatical distance between two words is the difference between their grammatical positions in the same text stream. Grammatical distance is not generally defined for words in different text streams.

Finally, in a step 823, the computed results for the wordᵢ-wordₖ pair are placed in entry 819, which is then put into database 811.

Distances Between Words

In an embodiment of the present invention, the vertical, horizontal, and diagonal distances are simply scalar numbers expressing the distance between the centers of the bounding boxes, as if the words were considered as occupying points, rather than being spread out over a region. In another embodiment of the present invention, these distances are composite numbers expressing the maximum and minimum distances, thereby reflecting the extents of the bounding boxes.

It is noted that the horizontal distance between two words will be small if both words are in the same column of a table or on the same Y-axis of a chart, even if the grammatical distance between the words is large. Likewise, it is noted that the vertical distance will be small if both words are in the same row of a table or on the same X-axis of a chart, even if the grammatical distance between the words is large. Moreover, a short distance between words on the screen—even if the words are generated by separate applications—is considered as possibly indicating an effort by the user to look at the words together. In embodiments of the present invention, such a proximity is therefore considered as worthy of notice.

Likewise, in an additional embodiment of the present invention, the difference in time between the appearances of the words is a single number expressing the time in seconds between the centers of their respective appearances on screen, as if the words appeared on the screen for only an instant. In yet another embodiment of the present invention, this time difference is a composite number expressing the maximum and minimum differences in time, thereby reflecting the durations of their respective appearances. As previously noted, the distances can be expressed in any convenient units, including, but not limited to: pixels; screen percentage; centimeters (or the equivalent thereof); and inches (or the equivalent thereof). Time difference can also be expressed in any convenient measure of time, such as seconds, minutes, etc. The registering and detection of such time differences is a novel feature of the present invention. The appearance of related words on the screen within a short time interval is an important occurrence, even if the words do not appear together simultaneously. In an embodiment of the present invention, the relative time difference between the appearance of one data word on a given screen and the appearance of another data word on a different screen is calculated.

In an embodiment of the present invention, the grammatical distance between the words is an integer representing the number of consecutive words from wordᵢ to wordₖ. For example, in FIG. 7, the grammatical distance between word 611 and word 623 is 5. The grammatical distance between word 617 and word 623, however, is undefined, because word 617 and word 623 do not appear in the same window.

Meta-Data Parameters and Their Significance

In addition to capturing and recording the information that is visible on the workstation screen to the user, an object of the present invention is to capture, record, and quantify various user actions that serve as indicia of the user's interest in, and use of, that information.

Following is a non-limiting list of parameters that are useful to detect:
For each time the user scrolled a particular application window, the scroll-rest position in that window. Analyzing this meta-data discloses the dynamics of the user's scrolling pattern for that window. This can tell whether the user was looking for something specific, was reading the document from beginning to end, or was merely casually glancing at the document.
The duration of time from the launching of a particular application to the closing of that application. Analyzing this meta-data reveals behavior patterns that characterize the style and purpose of the user's work. For example, if the user opens a document unintentionally, such as by accidentally double-clicking on a file (and thereby launching the related application for that document), the normal behavior pattern would be to close the application right away, upon realizing the error.
The number of times the user performed a “find” operation, copied text to another window, initiated a print command, and performed a file “save as” operation. These meta-data parameters are highly noteworthy, because they are indicia of misappropriation and misuse of information, especially when cross-correlated.
   Application Sequences

Users often employ a small set of applications in a particular sequence. Thus, according to an embodiment of the present invention, common sequences are tracked in order to identify exceptions. To illustrate this, suppose the specified applications are identified as A, B, C, and D, and let the notation X represent the launching of an application X, and let the notation X represent the closing of that application. A particular sequence could then be represented as AAABBAC. The sequence need not include the closing of running application(s), because users often leave applications running when terminating their current workstation session. A prolonged period of inactivity, however, may signify the end of the current sequence.

Sequences can be treated in terms of the well-known Markov chains, and analyzed statistically. According to an embodiment of the present invention, a general statistical distribution of short sequences is derived, and may be compared with the specific sequences exhibited during a session to highlight deviations from normal use.

Application Records

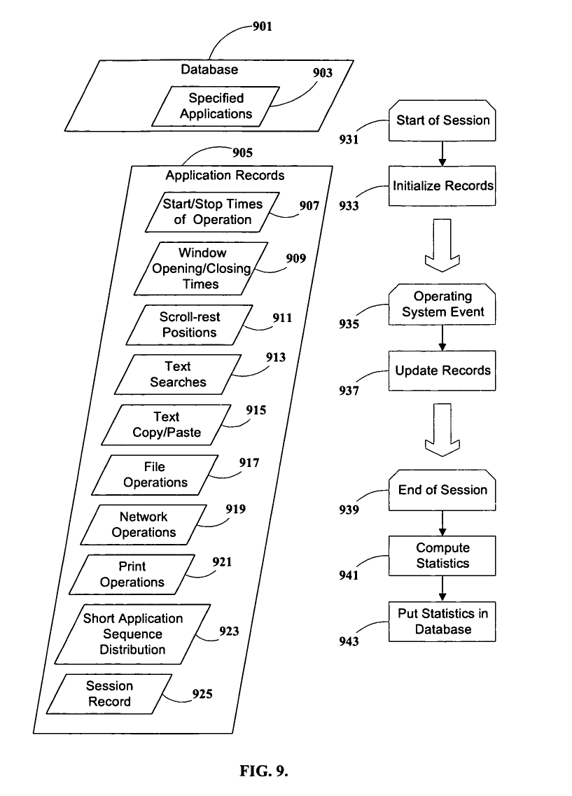

The term “application record” herein denotes any record of the actions involving a software application running on the workstation. Such action includes, but is not limited to: any user interaction with the application, via keyboard or pointing device; any display of information by the application on the workstation screen; any user-visible interaction of the application with the Graphical User Interface (GUI) of the workstation, such as the opening or closing of a window; any retrieval or storage of information, such as via file access or creation; any reception or transmitting of information, such as over a network, sending or receiving e-mail, and so forth; and any printing or other hard-copy output of information. As illustrated in FIG. 9, application records are compiled for each application that runs on the workstation, and are placed in a database 901. In an embodiment of the present invention, database 901 is the same database used for storing word relationship records (such as database 811 in FIG. 8). Database 901 also contains a list of specified applications. The term “specified application” herein denotes an application designated by administrative personnel as normally used in the workflow. Word processors, e-mail utilities, spreadsheet programs, and database applications, are non-limiting examples of typical specified applications. User information-viewing statistics can thus be compiled in the aggregate for a set of specified applications, in addition to information-viewing statistics for applications on an individual basis.

An application record set 905 contains application records for each individual application. Application records include, but are not limited to: start/stop time records 907; window opening/closing time records 909; scroll rest position records 911; text search records 913; text copy/paste records 915; file operation records 917; network operation records 919; print operation records 921; and a short application sequence distribution 923. Also included is a session record 925. File operations include: file open; file create; file copy; file move; file rename; file delete; file save; and file “save as”. Network operations include, but are not limited to: File Transfer Protocol (FTP) operations; network server access; World-Wide-Web access; file upload and file download; and e-mail operations. Network operations also include operations performed via a proxy.

The above operations also encompass the results of automatic application functions, such as automatic file save processes, and operating system registry processes.

Method for Logging Application Records

FIG. 9 illustrates a flowchart of a method for the compilation and compiling of application records according to an embodiment of the present invention. To begin, at a session start 931, an initialize record operation 933 is performed. This deletes all existing records in application record set 905 and creates a new session record 925 with the starting time of the session.

Next, upon the occurrence of any operating system event, the records of application record set 905 are updated. Operating system events are generally defined for any event for which there is an operating system notification or message. Application events are operating system events which are relevant to specific applications. These include, but are not limited to GUI control triggers; window events; and text events.

A non-limiting example of a trigger event is the appearance on the screen of certain error messages, system notifications, or requests for information from the user. These may indicate that the operating system or a running application is a risk of “crashing”. In such case, knowing what was on the screen just before the crash is valuable in diagnosing the event. It is thus desirable to capture the screen before making the next step (such as answering “yes” or “no”) that may actually cause the crash.

The term “GUI control trigger” herein denotes any user-activation event of GUI controls and encompass the results of common user GUI commands via keyboard or pointing device (e.g., mouse), including, but not limited to: menu selection; pointing-device click; pointing device cursor move; pointing-device rollover; pointing device drag-and-drop; GUI button push; GUI selection box check; GUI radio button check; drop-down list activation; list selection; GUI scroll; object selection; text selection; and keyboard shortcuts and accelerators. Specific GUI control triggers include, but are not limited to: key press and release; pointing device button press and release; and pointing device cursor movement.

The term “window event” herein denotes any event that changes or signals a change in the state of a window. GUI control triggers (see above) can initiate window events. Window events include, but are not limited to: window open, close, and about-to-close; window get and lose keyboard focus; window mouse capture; window refresh (or repaint); window move; window resize; window minimize, maximize, and restore; window dock, tile, and cascade; window show and hide; and window scroll.

The term “text event” herein denotes any event that changes the visibility of text on the screen. Text events include, but are not limited to: the appearance or coming into view of a specified segment of text on the screen; the disappearance or going out of view of a specified segment of text from the screen; and a change in formatting of a specified segment of text.

Updating the records of application record set 905 includes, but is not limited to: revising existing application records; creating new application records; and filling in fields of application records. For example, upon launching an application, an application start/stop time record 907 is created and added to application record set 905, containing the application ID (from the operating system) and the time of launch. When that application is closed, either that start/stop time record is updated with the stop time, or another start/stop time record 907 is created with the stop time. Likewise, when a window is opened, a new window opening/closing time record 909 is created, containing the application ID and the window ID (from the operating system) the time of opening, and the window extent and position on the screen. As another example, a scrolling operation within a window of an application is an operating system event (or combination of several such events) that will result in the creation of a new scroll rest position record 911 containing the time, application, window, and final scroll rest position.

Finally, upon an end of session 939, a compute statistics operation 941 calculates various statistical values from the application records of application record set 905, and creates a relevant application record containing those statistical values in separate fields. Calculated statistical values and their fields include, but are not limited to: maximum and minimum value fields; median value fields; average value fields; standard deviation value fields; and total value fields. As a non-limiting example, with respect to window opening/closing time records 909, relevant statistical values can include: the maximum and minimum number of windows open at the same time; the median and average number of windows open at the same time; the maximum and minimum time duration that a window was open; the average time duration that a window is open; and the total number of windows opened for that application.

As a non-limiting example, a statistical record can contain fields such as:
total number of windows opened during the session for the applications in specified application set 903;
total number of windows opened during the session for the applications not in specified application set 903;
maximum scroll-rest position for a window;
average scroll-rest position for a window;
maximum time an application was running;
average time a set of applications were running;
maximum number of times text was copied out of an application;
average number of times text was copied out for a set of applications;
maximum number of print commands from an application;
average number of print commands from a set of applications;
maximum number of “save as” commands from an application;
average number of “save as” commands from a set of applications;
maximum number of text find commands from an application;
average number of text find commands from a set of applications; and
the number of occurrences of a particular application sequence.

In an embodiment of the present invention, specified application set 903 is used to compute aggregate statistics for the set of specified applications. As a non-limiting example, if specified application set 903 contains a word processor application, a spreadsheet application, and an e-mail utility, statistics would be calculated for the total number of text copy and paste operations among all three of these applications. In another embodiment of the present invention, statistics are also computed for non-specified applications, i.e., applications which are launched by the user during a session, but which are not contained in specified application set 903.

As part of compute statistics operation 941, session record 925 is updated with the session closing time, or a new session record 925 can be created with this information.

Following compute statistics operation 941, there is a put statistics in database operation 943 to finish the session logging.

Screen List and Database Compacting

In an embodiment of the present invention, all the records of application record set 905, including the computed statistics, are put into database 901. In another embodiment of the present invention, only the computed statistics are put into database 901. Keeping all the records has the advantage of maintaining a complete account of the user session, but can result in a large database volume. Keeping only the computed statistics involves a reduced database size, but loses information because only an abstract of the user sessions is retained. In yet another embodiment of the present invention, database 901 is compacted, so that keeping all the records consumes less storage.

It is possible to compress screen list 803 and database 811 (or database 901) through well-known lossless data compression methods, such as the popular Lempel-Ziv-Huffman algorithm, but such compression methods are primarily intended for data transmission and/or inactive storage, and are not suited for active data access, because access to compressed data first requires a full decompression. This not only requires additional time, but also defeats the intended purpose of the compression. To compact screen list 803 and database 811 (or database 901) while still permitting active data access without decompression, it is possible to perform a data reduction that decreases data volume while preserving the general properties and utility of the database.

According to an embodiment of the present invention, a screen list and/or database may be compacted by processes including, but not limited to:
eliminating data words not in the active window (i.e., words not in the window that currently has the keyboard focus);
eliminating data words that are unchanged from another window;
eliminating data words predetermined to carry little or no information (e.g., “a”, “an”, “the”), as well as other non-interesting text, such as template “boilerplate”; in an embodiment of the present invention, such words and phrases are included in a list; in another embodiment of the present invention, the list is application-dependent (as a non-limiting example, the word “slide” may be not interesting in PowerPoint, but may be interesting in Word);
replacing common long data words by a short index number;
eliminating repetitions of data words;
eliminating text that cannot be changed by a user, and which has no significance to the data of an application, such as “help” text;
eliminating text that appears on the screen only briefly during user scrolling, and which does not stay on the screen long enough for reading;
eliminating text that is identical to text that was recorded at another client; in a non-limiting example, if ten employees are reading the same document, the system can record the document, and provide a link for users to this record; and
replacing text in a browser window with a link to that text.

In the above, “eliminating” is also construed to include “ignoring”—that is, skipping over the specified categories of text without entering them into the database.

In an embodiment of the present invention, words that are predetermined to carry little or no information are listed in a special dictionary/word index, which also lists common long words to be replaced by a short index number. Typically, words predetermined to carry little or no information are static and do not change over time, whereas common long words are generally added to the dictionary/word index as text is being processed and new long words are encountered.

It is noted that some compacting can be applied during data word capture, as illustrated in FIG. 8 by the use of subset criteria 805, as described previously.

Some of the above compaction techniques involve a loss of data, wherever words are eliminated. However, based on the analysis algorithms, this data loss does not entail a significant loss of information.

System for Capturing Collecting, Analyzing and Reporting Meta-Data

FIG. 10 is a block diagram of a system 1001 according to an embodiment of the present invention, to generate a report 1039 of information viewed on a workstation 1003, according to an administrative query 1037. In FIG. 10, system 1001 is shown as logically separate and independent of workstation 1003. Physically, however, part or all of system 1001 may be incorporated into workstation 1003. In one embodiment of the present invention, system 1001 is physically incorporated within workstation 1003, and in another embodiment, system 1001 is physically independent of workstation 1003 and is externally connected thereto, such as by a network.

Workstation 1003 contains an operating system 1005, a display 1007, a keyboard 1009, and a mouse 1011 or equivalent pointing device. For purposes of describing the present invention, display 1007, and/or keyboard 1009, and/or mouse 1011 may represent physical devices or software drivers for such devices.

System 1001 contains a data word content characterizer 1015, which characterizes data words as previously described, to create a screen list 1017. A data word selector 1021 selects data words from screen list 1017 to produce a data word subset 1019, according to selection criteria from a query engine 1035, to reflect administrative query 1037, which is a query from an administrator or other investigator who wishes to examine, audit, or analyze the information viewed by the workstation user. A data word relationship analyzer 1023 determines interrelationships between data words in data word subset 1019 and enters these interrelationships in a database 1025. In addition, a user activity characterizer and analyzer 1027 determines user patterns, by collecting user commands via keyboard 1009 and mouse 1011 regarding: the launching of applications; positioning and scrolling of windows; finding of text; copying of text; opening, creating, writing of files; and printing of text or files. Information collected by user activity characterizer and analyzer 1027 is also placed in database 1025. A database manager 1029 handles queries from query engine 1035 and accesses database 1025 to respond to query 1037, and outputs report 1039.

Database manager 1029 includes a dictionary/word index 1031 for compacting database 1025 (as described previously), and a statistical unit 1033 to enable the compilation of statistical data on user activities, such as computing averages and standard deviations, generating and analyzing histograms, and so forth. For simplicity, dictionary/word index 1031, and statistical unit 1033 are illustrated in FIG. 10 as a part of database manager 1029, but either or both of these can alternatively be separate from database manager 1029.

Audit Trail Reports

FIG. 11 conceptually illustrates an example of an audit trail screen 1100 according to an embodiment of the present invention. A title 1101 indicates that this report tracks the propagation of the name “Rogovsky” proximate to the name of a European city and proximate to a form of communication (hereinafter denoted as the “target words”) during the month of February, 2002. A user name 1103 is associated with a particular workstation. A popup balloon 1105 highlights a confluence of screen words related to the name “Rogovsky”, a European city (“Brussels”), and a form of communication (“your fax”) that was displayed within a region of 2.9 centimeters on the screen, and which was saved in a file. It is noted that in this case the name “Rogovsky” was spelled “Rogofsky” when displayed on the screen. Use of the well-known “Soundex” technique, however, allows identification and capture of variant spellings of names. A circled group 1107 highlights a concurrence of an open file containing the target words, with an appearance on the screen by the target words for a duration greater than 10 minutes, with a printout containing the target words.

Through the use of screens and reports, such as illustrated in FIG. 11, administrative personnel can analyze and monitor database 811 (FIG. 8) to ascertain that an organization's “acceptable use policy” for information is being observed—or if not, to determine which users are abusing their information access rights.

In an embodiment of the present invention, the system confirms that the software is operational on a given client computer, by sending a random number to be displayed on the window-frame of one of the running applications or on the system tray bar, in a color of the background. Such a number is not visible to the operator and does not interfere with his/her work. The random number, however, number is read by the system and reported as part of the screen. Failure of the client computer to report the presence of the random number within a reasonable time after being put on the screen indicates that the client is not being monitored by the system at that time. Using a random number makes it impossible for the client to guess the number and thereby counterfeit the validation. The system logs the random number, time, and client ID upon sending the random number, and uses this log as a basis for an “inventory control” of the reports.

While the invention has been described with respect to a limited number of embodiments, it will be appreciated that many variations, modifications and other applications of the invention may be made.

1. A method of determining the sensitive information exposed to a workstation user by persistently storing the information appearing on a workstation screen for further analysis of the stored information, the method comprising:
getting a data word from the workstation screen;
getting a position of said data word;
recording and storing said data word in a persistent database; and
analyzing the contents of said persistent database.

2. The method of claim 1, wherein said data word is furthermore associated with, and recorded in said screen list with, at least one attribute selected from the group consisting of:
the screen on which said data word was displayed;
the date and time said data word appeared on the workstation screen;
a the date and time said data word changed position on the workstation screen;
the date and time said data word disappeared from the workstation screen.

3. The method of claim 1, wherein said data word is displayed by a software application within a window, and wherein said data word is furthermore associated with, and recorded in said screen list with, at least one attribute selected from the group consisting of:
said software application; and
said window.

4. The method of claim 1, wherein said getting a data word is initiated by an event included in the group consisting of:
keystroke event;
pointing device event;
operating system event;
text event;
GUI control trigger;
application event;
timer event; and
error message event.

5. The method of claim 4, wherein said data word is furthermore associated with, and recorded in said screen list with, said event.

6. The method of claim 1, wherein said screen list is compacted by a process selected from the group consisting of:
elimination of data words predetermined to carry little or no information;
elimination of repetition of data words; and
replacement of common long data words by an index number.

7. The method of claim 1, wherein said screen list contains data words appearing in at least one window, at most one window of which is an active window, and wherein said screen list is compacted by a process selected from the group consisting of:
eliminating data words not contained in an active window; and
eliminating data words unchanged from another window.

8. The method of claim 1, further comprising:
sending a random number to the workstation screen in such a way that said random number is not visible to the workstation user;
detecting the display of said random number on the workstation screen and sending a report of said display; and
receiving said report.

9. A method for determining the associative proximity between a first data word and a second data word, each data word having a position on a workstation screen, each position having a horizontal component and a vertical component, the method comprising:
persistently storing the workstation screen position of the first data word;
persistently storing the workstation screen position of the second data word; and
calculating a distance between the first data word and the second data word according to a function selected from the group consisting of:
the absolute value of the difference between the horizontal components of the position of the first data word and the second data word;
the absolute value of the difference between the vertical components of the position of the first data word and the second data word;
the square root of the sum of the squares of the difference between the horizontal components of the position of the first data word and the second data word and the difference between the vertical components of the position of the first data word and the second data word; and
the time difference between the appearance of the first data word and the second data word on the workstation screen.

10. The method of claim 9 performed by a free text database search engine.

11. The method of claim 9, where the first data word appears on a first screen and the second data word appears on a second screen, the function furthermore being the relative time difference between the appearance of the first data word and the second data word.

12. The method of claim 9, furthermore comprising:
creating a database record containing the first data word, the second data word, and said distance;
and placing said database record in a database.

13. The method of claim 12, wherein said database is compacted by a process selected from the group consisting of:
eliminating data words predetermined to carry little or no information;
eliminating repeated data words;
replacing common long data words by an index number;
eliminating text appearing on the workstation screen for a period too short to read;
eliminating text appearing in a list of non-interesting text;
eliminating text identical to text appearing on another workstation screen.

14. The method of claim 12, wherein said database contains data words appearing in at least one window, at most one window of which is an active window, and wherein said database is compacted by a process selected from the group consisting of:
eliminating data words not contained in an active window; and
eliminating data words unchanged from another window.

15. A method for characterizing the relationship between a first data word and a second data word, each data word having a time of appearance on a workstation screen, the method comprising:
obtaining the time of appearance on the workstation screen of the first data word;
obtaining the time of appearance on the workstation screen of the second data word; and
calculating the time difference between the appearance of the first data word and the appearance of the second data word.

16. The method of claim 15, furthermore comprising:
creating a database record containing the first data word, the second data word, and said time difference; and
placing said database record in a database.

17. The method of claim 16, wherein said database is compacted by a process selected from the group consisting of:
eliminating data words predetermined to carry little or no information;
eliminating repeated data words; and
replacing common long data words by an index number.

18. The method of claim 16, wherein said database contains data words appearing in at least one window, at most one window of which is an active window, and wherein said database is compacted by a process selected from the group consisting of:
eliminating data words not contained in an active window; and
eliminating data words appearing in a second window, wherein said data words are unchanged from said second window.

19. A method for characterizing the relationship between a first data word and a second data word, each data word having a grammatical position in a text stream appearing on a workstation screen, the method comprising:
obtaining the grammatical position of the first data word; obtaining the grammatical position of the second data word; and
calculating the difference between the grammatical position of the first data word and the grammatical position of the second data word.

20. The method of claim 19, furthermore comprising:
creating a database record containing the first data word, the second data word, and said difference; and
placing said database record in a database.

21. The method of claim 20, wherein said database is compacted by a process selected from the group consisting of:
eliminating data words predetermined to carry little or no information;
eliminating repeated data words; and
replacing common long data words by an index number.

22. The method of claim 20, wherein said database contains data words appearing in at least one window, at most one window of which is an active window, and wherein said database is compacted by a process selected from the group consisting of:
eliminating data words not contained in an active window; and
eliminating data words appearing in a second window, wherein said data words are unchanged from said second window.

23. A computer program product comprising a storage medium for storing a computer program operative to perform a method of any of claim I through claim 22.

24. A computer system configured to execute a computer program interacting with a database including a database record for logging and characterizing a user's manipulation of a workstation having a graphical user interface, a set of applications including specified and non-specified applications, and windows with scroll-rest positions, the database record comprising at least three different fields selected from the group consisting of:
the total number of windows opened during a workstation session, for specified applications;
the total number of windows opened during a workstation session for non-specified applications;
the maximum scroll-rest position for a window; average scroll- rest position for a window;
the maximum time an application was running; average time a set of applications were running;
the maximum number of times text was copied out of an application;
the average number of times text was copied out of a set of applications;
the maximum number of print commands from an application;
the average number of print commands from a set of applications;
a the maximum number of “save as” commands from an application;
the average number of “save as” commands from a set of applications;
the maximum number of text find commands from an application;
the average number of text find commands from a set of applications; and
the number of occurrences of a particular application sequence.

25. A system for capturing, collecting, analyzing, and reporting information about data displayed on a workstation to a user according to a query, the system comprising:
a data word content characterizer, for creating a screen list;
a data word selector, for creating a subset of said screen list according to the query;
a data word relationship analyzer, for determining interrelationships between words in said subset;
a database for containing said interrelationships;
a user activity characterizer, for determining user patterns; and
a database manager.

26. The system of claim 25, furthermore comprising a statistical unit for compiling statistical data on user activities.
